(19) United States
(12) Patent Application Publication
(10) Pub. No.: US 2010/0060581 A1
(43) Pub. Date: Mar. 11, 2010

(54) System and Method for Updating Live Weather Presentations

(76) Inventors: John S. Moore, Middleton, WI (US); Andrew C. Rice, Madison, WI (US); Aaron M. Avery, Madison, WI (US)

Correspondence Address: BOYLE FREDRICKSON S.C., 840 North Plankinton Avenue, MILWAUKEE, WI, 53203, US

(21) Appl. No.: 12/435,072

(22) Filed: May 4, 2009

Related U.S. Application Data
(60) Provisional application No. 61/049,947, filed on May 2, 2008.

(51) Int. Cl. G06F 3/033

(52) U.S. Cl. 345/163

(57) ABSTRACT

A computer-implemented method of preparing live weather presentations including preparing a computer readable run-down describing graphical elements and associated data links inserting current weather data into the graphical elements to be used as a graphical portion of a live weather presentation. The method further includes, at first intervals, using the run-down to prepare an audiovisual live weather presentation by capturing at a first data rate, a live weather presenter describing and displaying graphical portions generated by the run-down augmented with current weather data at the first time, and to transmit the same in real time. The method yet further includes, at second intervals more frequent than the first intervals, using the run-down to prepare an audiovisual live weather presentation by capturing at a second data rate lower than the first data rate, a live weather presenter describing and displaying graphical portions generated by the run-down augmented with current weather data at the second time and to store the same on the web for access by users.

### CROSS-REFERENCE TO RELATED APPLICATIONS

This application claims priority based on U.S. Provisional Application No. 61/049,947, filed May 2, 2008, the entirety of which is herein incorporated by reference.

### BACKGROUND OF THE INVENTION

Live weather presentations, in which a live presenter explains graphical information related to current and predicted weather, for example, as seen on broadcast television stations, provide a convenient and enjoyable way of obtaining information about the weather.

Such live weather presentations are labor intensive, requiring the cooperation of many trained individuals, including, for example, the presenter, meteorologists, cameramen, sound engineers, production engineers and the like to produce. The weather data provided by such live weather presentations can be current through the use of live weather data feeds; however, the decisions about the form of the presentation and programming of the presentation, in a so-called “run-down”, requires substantial advance planning and effort.

Normally, a live weather presentation will include a sequence of graphical elements that are defined and listed in the run-down. For example, one simple graphical element may be a map showing high temperatures for the day. This graphical element requires run-down entries identifying the map graphic as well as locations of temperatures to be displayed on the map and links to live temperature data that will be supplied during the presentation. Animations, colors and segues and other graphical parameters related to the graphical elements must also be pre-programmed.

With the increasing use of the Internet to obtain weather information, it would be desirable to be able to provide live weather presentations on a more frequent basis than is done by typical broadcasters. The cost of creating such presentations, however, normally limits Internet weather providers to rebroadcasting video recordings with stale weather data based on as few as three live weather presentations per day.

### SUMMARY OF THE INVENTION

The present invention provides a weather graphics system suitable for generating graphics for broadcast-quality weather presentations that also may operate in a second mode permitting reuse of the graphic elements for less labor intensive desktop web broadcasts or the like. In this way, the demand for current live weather presentations can be satisfied with a flexible combination of standard broadcast type weather programs and simpler Web-type weather programs.

### BRIEF DESCRIPTION OF THE DRAWINGS

FIG. 1 is a simplified representation of a broadcast live weather presentation employing the weather graphics system of the present invention in a first mode to create presentation graphics using a run-down program and live weather data, and a simplified desktop weather presentation employing the weather graphics system in a second mode to create a downloadable weather program suitable for uploading to the web and using the same run-down program and live weather data to produce;

FIG. 2 is a block diagram showing a run-down file defining presentation graphics linked to current weather data;

FIG. 3 is a block diagram of the weather graphics system of FIG. 1 showing the configurability of its elements in first and second modes for broadcast or web delivery of weather presentations;

FIG. 4 are screenshots showing one transition between a presenter image and weather graphic data suitable for a web broadcasts; and

FIG. 5 is a timing diagram showing application of the present invention in generating rapidly updated live weather presentations.

### DETAILED DESCRIPTION OF THE INVENTION

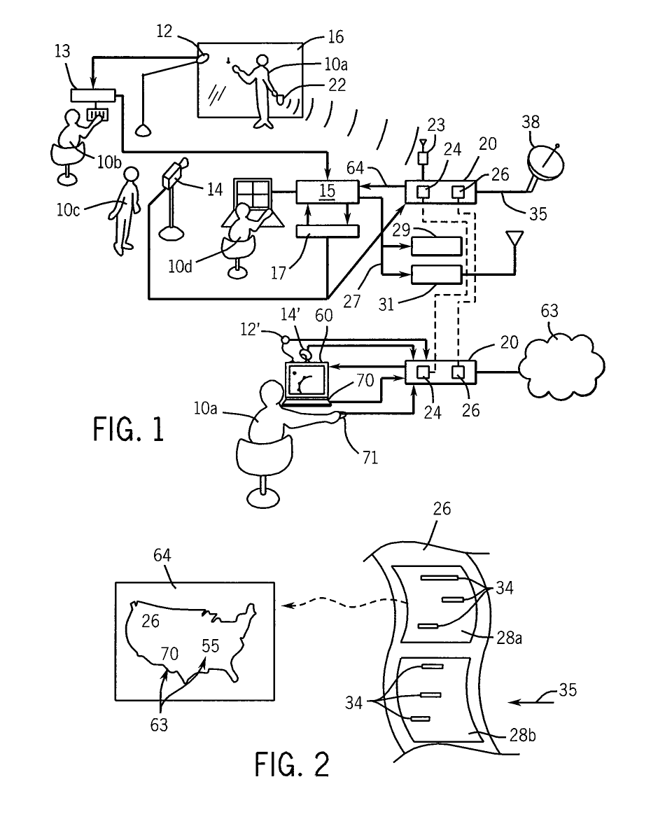

Referring now to FIG. 1, the generation of a broadcast-quality live weather presentation involves multiple professionals 10a-10d. Generally a weather presenter 10a is recorded by a sound engineer 10b using a broadcast-quality microphone 12 providing a signal to a soundboard 13 which provides processed sound to a production switcher 15 controlled by a production engineer 10d.

The weather presenter 10a may stand in front of a key wall 16 (e.g., green screen) to be filmed by a cameraman 10c using a high definition camera 14. The camera 14 may provide a video signal to a chroma-keyer 17 and to the weather graphics system 20 of the present invention.

The weather graphics system 20 may comprise a desktop type computer providing necessary graphics and sound cards to interface with the signals to be described. For a broadcast weather presentation, the weather graphics system 20 provides for weather graphics 64 in the form of a video signal to the production switcher 15 which may provide it to the chroma-keyer 17. As is understood in the art, the chroma-keyer 17 replaces the image of the key wall 16 with the weather graphics 64 to present a composite video signal 27 showing the presenter 10a superimposed on the weather graphics 64.

The composite video signal 27 may be recorded by a recorder 29 and/or presented to a broadcast transmitter 31 for broadcast over the air or through a cable network system.

The weather graphics system 20 executes a stored program 24 to generate weather graphics 64 based on a computer readable run-down 26 that is prepared in advance and provides a graphical script for the graphics portion of the weather presentation. Referring also to FIG. 2, the run-down 26 includes definitions of different graphic elements 28a, 28b, for example, representing weather maps or the like. Each graphical element includes data link tags 34 which may, during the broadcast, be updated with live weather data 35 obtained from a weather data source 38, for example via satellite or Internet linkage. The data link tags 34 indicate a source of the data and the location of representation of the data in the graphic element 28 as well as other visual properties such as formatting. In this way the weather graphics 64 may present the preprogrammed graphic elements 28, for example the weather map, superimposed with live real-time weather data, for example, temperatures 63.

The graphic elements 28 may also define animation or various procedures that may be implemented by the presenter 10a, for example, drawing lines or moving elements about the weather graphics 64 under commands received from a handheld queuing device 22 held by the presenter 10a transmitted through a receiver 23. In addition, the presenter 10a may make use of the presenter's outstretched hand to indicate a location of the graphic effects wherein the tip of the presenter's outstretched hand provides a location of the effect and the handheld queuing device 22 selects among different effects and controls the timing of the effect.

Various static data elements, for example, images may be referenced by the elements 28 through links to files stored on the weather graphics system 20. The graphic elements 28 may further define, for example, text information for a crawler displayed at the bottom of the television screen during the weather program or other programming to indicate important weather conditions.

Referring still to FIG. 1, the weather graphics system 20 with the program 24 and the same run-down 26 used in a first mode for a broadcast weather program may also be used in a second mode suitable for a broadcast prepared in a desktop environment. In this second mode, the presenter 10a may connect a keyboard 70, mouse 71 and monitor 62 to the weather graphics system 20 together with a Web type camera 14′ and microphone 12′. The program 24 operating in the second mode allows the same run-down 26 to be used in this new environment. Generally the demands of the desktop environment production will be lower than that of a broadcast weather presentation and so the image quality and sound quality standards may be relaxed, however this is not a requirement of the invention.

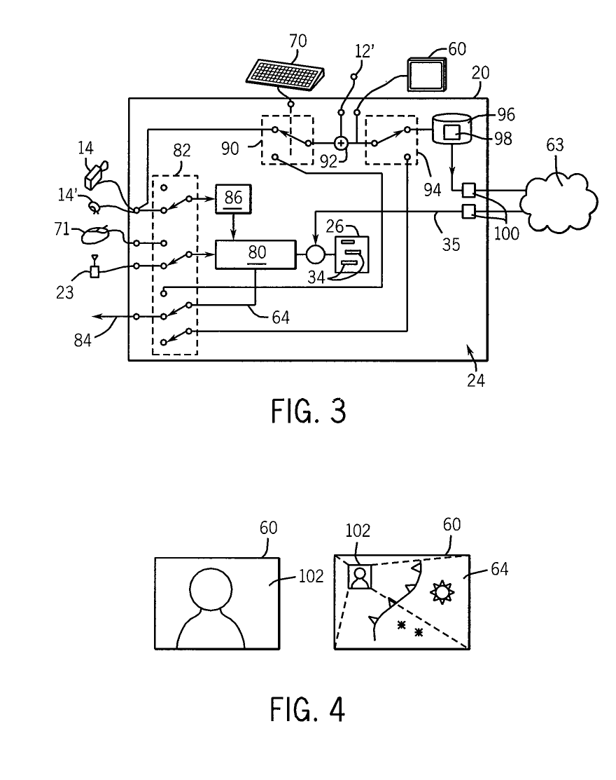

Referring now to FIG. 3, the weather graphics system 20 operable in these two modes may be implemented with a graphics generating computing system controlled according to program 24 to implement a number of functional blocks and switching elements that will now be described. The functional blocks and switch elements may be implemented in software or any combination of hardware and software as will be understood by those of ordinary skill in the art.

Generally the weather graphics system 20 implements a graphics engine 80 that may read a stored run-down 26 and weather data 35 associated with data link tags 34 in the run-down 26, the weather data 35 obtained from the Internet or the like.

In a first mode for studio use, weather graphics 64 generated by the graphics engine 80 are routed through a mode switch 82 which, in a first “broadcast mode”, provides weather graphics 64 to the video output 84 that may be connected to the production switcher 15 (shown in FIG. 1). Control of the graphics engine 80 is provided by signals received from the receiver 23 routed through mode switch 82 to the graphics engine 80 and by a video signal from camera 14 routed by the mode switch 82 to a cursor control 86. Cursor control 86 provides position signals derived from a location of the outstretched hand of the presenter 10a using, for example, MagicTRAK™ software available from WeatherCentral, Inc. of Madison, Wis. and described in U.S. Pat. No. 5,270,820 “Method And Apparatus For Tracking A Pointing Device In A Video Field” hereby incorporated by reference.

In a second mode for web use, the mode switch is changed to a second state disconnecting the cursor control 86 from the video camera 14 and connecting the graphics engine 80 directly to the mouse 71 which provides both position information (normally provided by the cursor control 86) as the mouse 71 is moved on a surface and activation information (normally provided through receiver 23) by the mouse buttons.

The weather graphics 64 of the graphics engine 80 is routed by mode switch 82 to a first throw of a video switch 90, the second throw of which connects to camera 14′. The keyboard 70 activates the video switch 90 (preferably by tapping the spacebar) causing the output of the video switch 90 to provide either a live image of the presenter 10a taken by camera 14′ or the weather graphics 64 generated by the graphics engine 80. This switched signal is sent to an audio summer 92 which receives a signal from the microphone 12′ for continuous audio regardless of whether a live image of the presenter 10a or weather graphics 64 are being used.

The video from the video switch 90 connects to the computer monitor 60 for viewing by the presenter 10a and also connects by an output switch 94 (controllable by input parameters entered by the presenter 10a at the start of a recording session) to a storage device such as a hard disk 96 storing a video file 98 for uploading through Internet port 100 to a Web server or the like. Alternatively (or in addition) the output switch 94 may route the video signal to the video output 84 for use in actual broadcast.

Referring now to FIG. 4, using the keyboard 70, the presenter 10a may switch between an image 102 of the presenter 10a shown on computer monitor 60 and the weather graphics 64. In one embodiment the image 102 may be provided as an inset in the weather graphics 64 when the weather graphics 64 are displayed on the computer monitor 60. In either case, weather graphics 64 and a presenter image 102 may be integrated without a chroma-keyer.

The dual-mode operation of the program 24 permits use of a single run-down 26 prepared for a standard broadcast weather presentation in augmenting weather presentations using the same run-down but having updated weather data so that the production costs may be controlled. By sharing files and hardware, and by relaxing production values as is appropriate for different delivery mechanisms, a much higher updating rate of live weather presentations with current weather data may be provided as well as a more detailed review of the weather data.

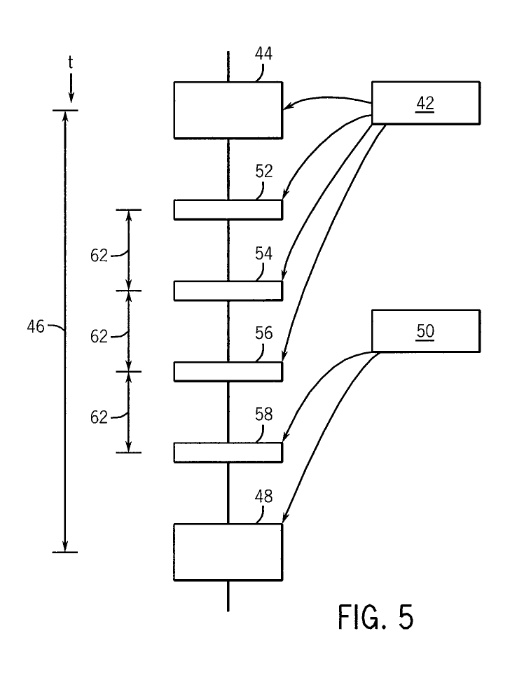

Referring now to FIG. 5, in a typical application, a run-down 26 will be prepared as indicated by process block 42 and used to prepare a broadcast weather broadcast 44. At a later time, a new run-down 26 may be prepared as indicated by process block 50 and used for a second live broadcast 48. Generally, the interval 46 between these broadcasts 44 and 48 may represent an early evening and late evening broadcast or a morning broadcast and evening broadcast.

The run-down 26 prepared at process block 42 may also be used for a series of webcasts 52, 54, 56 having an interval 62 that may be less than interval 46 permitting multiple webcasts 52-58, for example, to occur between regular broadcasts 44 and 48. When a new run-down 26 is prepared at process block 50 it may be used for webcast 58 preceding regular broadcast 48.

This greatly simplified production, available when the weather graphics system 20 is used in the second mode, permits webcasts 52-58 to be repeated at a much higher update interval than can be obtained from broadcast-quality standards and yet in a manner that is fully acceptable to consumers. Further, in emergency situations presenter 10a may prepare weather presentation using the webcast style format for broadcast. Thus the webcast format should not be understood to be limited to webcasting but can be used, in fact, for broadcasting as noted above. During these web broadcasts, the graphic elements 28 may be described in more detail by the presenter 10a, as the Web permits a greater time allotment to conveying weather information. Further, the run-down 26 may include both shared elements and elements only used in the webcasts 52-58.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A weather graphics system comprising:
an electronic computer having input ports for receiving:
(i) audio data;
(ii) video data;
(iii) graphic trigger signals;
(iv) graphic spatial position signals;
(v) a mouse-type device;
(vi) a keyboard-type device; and
(vii) network signals;
and output ports for transmitting
(i) network signals; and
(ii) video signals;
and an electronic computer executing a stored program to
(a) in a first mode, operate a graphic engine according to a run-down program to output graphic images described by the run-down program as augmented by real-time weather data to the output port, the graphic images controlled by at least one of the video input signals or the graphic trigger device;
(b) in a second mode, operate the graphic engine according to the run-down program to generate a weather presentation switching between the output graphic image described by the run-down program as augmented by real-time weather data and a video image of a presenter, the graphic image controlled at least by the mouse type device and keyboard type of device.

2. The weather graphics system of claim 1, wherein the graphic images are controlled based on a location of a presenter's hand in the first mode.

3. The weather graphics system of claim 2, wherein graphic images are controlled based on a location of a cursor controlled by the mouse-type device in the second mode.

4. The weather graphics system of claim 1, wherein the electronic computer is configured to operate in the first mode during a first interval and in the second mode during a second interval, the second interval being a subset within the first interval.

5. A computer-implemented method of preparing live weather presentations comprising the steps of:
(a) preparing a computer readable run-down describing graphical elements and associated data links inserting current weather data into the graphical elements to be used as a graphical portion of a live weather presentation;
(b) at first intervals, using the run-down to prepare an audiovisual live weather presentation by capturing at a first data rate, a live weather presenter describing and displaying graphical portions generated by the run-down augmented with current weather data at the first time, and to transmit the same in real time; and
(c) at second intervals more frequent than the first intervals, using the run-down to prepare an audiovisual live weather presentation by capturing at a second data rate lower than the first data rate, a live weather presenter describing and displaying graphical portions generated by the run-down augmented with current weather data at the second time and to store the same on the web for access by users.

6. The computer-implemented method of claim 5, wherein the graphical portions are described and displayed based on a location of a presenter's hand in the first mode.

7. The computer-implemented method of claim 6, wherein the graphical portions are described and displayed based on a location of a cursor controlled by the mouse-type device in the second mode.

8. The computer-implemented method of claim 5, wherein the second intervals are subsets within the first intervals.
